(19) United States
(12) Patent Application Publication
(10) Pub. No.: US 2010/0211403 A1
(43) Pub. Date: Aug. 19, 2010

(54) Life Planning Services For Disabled Individuals

(75) Inventors: James F. Allsup, Scottsdale, AZ (US); Paul N. Gada, Olivette, MO (US); Scott P. Poston, Red Bud, IL (US)

Correspondence Address: Polster, Lieder, Woodruff & Lucchesi, L.C., 12412 Powerscourt Dr. Suite 200, St. Louis, MO, 63131-3615, US

(73) Assignee: Allsup, Inc., Belleville, IL (US)

(21) Appl. No.: 12/704,120

(22) Filed: Feb. 11, 2010

Related U.S. Application Data
(60) Provisional application No. 61/153,144, filed on Feb. 17, 2009.

(51) Int. Cl. G06Q 40/00; G06Q 50/00; G06Q 99/00; G06F 17/30; G06F 3/048

(52) U.S. Cl. 705/2; 705/35; 705/31; 705/304; 707/705; 707/E17.107; 715/764

(57) ABSTRACT

A comprehensive system for providing quality of life enhancing services to disabled individuals or qualifying participants comprising a plurality of services including life planning services, financial services, tax services, lump sum payment management services, Medicare Advisor Service, Social Security Disability Insurance representation, healthcare discount card and stored value card services.

### CROSS-REFERENCE TO RELATED APPLICATIONS

The present application is related to, and claims priority from, U.S. Provisional Patent Application Ser. No. 61/153,144 filed on Feb. 17, 2009, which is herein incorporated by reference.

### STATEMENT REGARDING FEDERALLY SPONSORED RESEARCH

Not Applicable.

### BACKGROUND OF THE INVENTION

The invention relates generally to methods and a system for providing an array of optimized services to a disabled individual including, but are not limited to, securing Social Security disability insurance benefits, management of lump sum payments of retroactive Social Security disability benefits, comprehensive lifestyle and financial planning for individuals with disabilities, Medicare Advisor Service, tax planning, healthcare discount services and financial management through the use of stored value cards and accounts.

Service organizations and companies sometimes referred to herein as Service Providers, through their employees often represent individual claimants before the U.S. Social Security Administration (SSA) for purposes of obtaining Social Security disability insurance (SSDI) benefits for disabled individuals. However, disabled individuals may require additional or supplemental services that extend beyond merely securing Social Security disability benefits. Often a physical or mental disability is life changing for the individual. Job loss resulting from a disability, for example, can result in profound changes in the individual's financial status. The disabled individual may need assistance in adapting to changed financial circumstances. By way of example, the disabled individual may need assistance in financial planning or money management during the pendency of a claim for SSDI payments. On average, it takes SSA thirteen months to process a claim for SSDI. Once SSDI is awarded, generally there is a retroactive benefit representing disability payments that should have been paid to the disabled individual by the SSA beginning with the sixth full month the disabled individual is off work due to the disability. Hence, the disabled individual may receive a lump sum award and need assistance or guidance in investment or management of the funds so as to maximize income or expeditiously apply funds to outstanding debt.

Currently, after the disabled individual has received SSDI for twenty-four months, regardless of age, he or she also becomes eligible for Medicare benefits. This includes Medicare Part A hospital benefits and Medicare Part B medical benefits. The disabled individual may qualify for Medicare Part D prescription drug coverage. Presently, the disabled individual must choose between a traditional Medicare plan and Medicare Advantage plans. Choosing the right plan can be difficult. The various coverages and qualifications are complex. The disabled individual may benefit from professional help in choosing a plan that is most beneficial for that individual given the particular circumstances of the individual's finances and stage in life.

Accordingly, it would be advantageous to provide a system through which a Service Provider or representative may interact with disabled individuals to facilitate the determination and delivery of optimized comprehensive life planning and financial services and additional assistance, together with standard Social Security and Medicare services. Disabled individuals require a variety of services that may not be currently offered as a package of benefits in the care industry or through their previous employer.

### BRIEF SUMMARY OF THE INVENTION

Briefly stated, the present disclosure provides methods, generally configured with a computer and software technology, for providing an optimized life plan including, an array of financial services, to a disabled individual based upon the particular individual's circumstances. The array of services may include, but is not limited to, obtaining SSDI benefits from the SSA, maximizing the amount of retirement benefits the disabled individual is entitled to at retirement, managing lump sum payments of disability benefits, providing tax counseling and financial planning services, Medicare Advisor Service, healthcare discount care and a stored value card.

One aspect of the invention includes a Disability Life Planning Center (DLPC), which includes centralized databases on an appropriately programmed computer which function as a repository of data specific to the disabled individual and data regarding the array of services offered under the present invention. When a disabled individual is referred to the DLPC, personal data is entered into the computer. The data is processed to determine whether the disabled individual is a candidate for one or more of the individual component services. The DLPC allows for centralized communication among the various component services, which can utilize the repository of data and coordinate an optimized life plan for the disabled individual through the DLPC.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings and Appendices which form part of the specification:

FIG. 1 is a basic relationship chart illustrating an overview of how a disabled individual or participant and a disability life planning system specialist or Service Provider may interact with one another in relation to the disability life planning system;

FIGS. 2A and 2B set forth an expanded flow chart illustrating steps associated with the initiation of service between a disabled individual or participant and the Service Provider as identified in FIG. 1;

FIG. 3 sets forth an expanded flow chart illustrating steps associated with the generation of a Disability Life Planning Service review of survey information provided by a disabled individual or participant, as identified in FIG. 1;

FIG. 4 sets forth an expanded flow chart illustrating steps associated with the review of generated reports for a disabled individual or participant, as identified in FIG. 1;

FIG. 5 is a screen capture illustrating an exemplary net worth calculator input interface;

FIG. 6 is a screen capture illustrating an exemplary home budget analysis calculator input interface;

FIG. 7 is a chart illustrating the relationship of components in the Disability Life Planning Center;

FIG. 8 is a screen capture illustrating an exemplary Medicare Advisor survey input interface.

Appendix A sets forth an example financial planning question, answer, and response summary associated with reverse mortgage planning.

Appendix B sets forth an example financial planning question, answer, and response summary associated with 401(K) planning.

Corresponding reference numerals indicate corresponding parts throughout the several figures of the drawings. It is to be understood that the drawings are for illustrating the concepts set forth in the present disclosure and are not to scale. Before any embodiments of the invention are explained in detail, it is to be understood that the invention is not limited in its application to the details of construction and the arrangement of components set forth in the following description, appendices, or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

The present invention includes a comprehensive planning and assistance service for disabled individuals or participants who may not be disabled, but who are otherwise qualified to participate in the various assistance programs provided by a Service Provider organization, such as Allsup, Inc., of Belleville, Ill. It will be understood by those of ordinary skill in the art that the terms disabled individual and participant are used herein to refer generally to an individual who is eligible or qualified to receive one or more benefits associated with the services provided by the Service Provider organization. Some of these services may be specifically directed towards individuals with qualifying disability, while others may be directed towards individuals who qualify due to advanced age or other selection criteria, such as income levels.

The present invention comprises a centralized organization center, which is operated and staffed by the Service Provider organization, and which may be referred to herein for purposes of description and clarity as a DLPC. The DLPC is the functional nerve center of the system of the present invention. The DLPC employs a properly programmed central computer system having a plurality of sub-systems or software modules that allows for the integration and management of data on all aspects of the invention. By way of example, the centralized computer can be appropriately programmed, and include appropriate databases, so as to perform analytic functions and report generation for components of a Disability Life Planning Service (DLPS), such as financial planning and for a Medicare Advisor Service (MAS), both of which will be described in greater detail below.

The DLPC is the central management center for a suite of services tailored to the needs of a disabled individual or a participant. One or more of the services may be offered or provided to a disabled individual or participant as result of appropriate evaluation and assessment, the application of which is referred to as the DLPS. The DLPS component of the present invention may include, but is not limited to, the following subcomponents: Social Security related tax decisions; management of lump sum payments, MAS, healthcare discount cards, and financial planning.

Social Security related tax decisions are associated with the payment of premiums for a long term disability, and how the long term disability benefits may be taxed. Once the disabled individual begins to receive SSDI, the disabled individual's tax structure is changed, and the disabled individual may benefit from tax counseling. Specific tax issues related to the special financial status of the disabled individual may be evaluated as well when considering Social Security related tax decisions. For example, the management of lump sum payments as part of the DLPS can provide the disabled individual with maximized and prudent use of lump sum SSDI payments.

The MAS aspect of the DLPS provides a disabled individual or participant with assistance in selecting between appropriate traditional Medicare plans and Medicare Advantage plans, as set out in detail below.

The disabled individual or participant may benefit from low cost prescription drug plans or the ability to obtain other medical products at a discount using a discount card. One aspect of the DLPS provides an evaluation of suitable options for healthcare discount cards to the disabled individual or participant after completing an evaluation of the disabled individual's or participant's current financial status.

A disabled individual's or participant's financial status is additionally evaluated by the DLPS as part of a financial planning component or software module, which may include: providing investment advice, such as identifying sound investment strategies tailored to the disabled individual's or participant's assets and needs; assistance with 401(k) decisions; and stored value card decisions. For example it may be necessary to determine if the disabled individual or participant can leave their 401(k) assets with their employer, if they must move the funds to a self-directed IRA or other investments, or if 401(k) withdrawals are required to provide the disabled individual or participant with sufficient funds. Some disabled individuals or participants may benefit from a having a stored value card, with a prepaid dollar amount or a debit account, to use to purchase necessities and control discretionary spending.

Various aspects of the software modules, components and subcomponents of the DLPC system of the present invention will be described hereinafter in greater detail. A disabled individual or participant often is in desperate financial need, yet may not realize there are many resources and ways for them to improve their financial situation. One aspect of the present disclosure is to provide a service or module that will evaluate the disabled individual's or participant's finances and provide specific recommendations on how to get appropriate financial help.

The DLPS of the present disclosure is an umbrella process that collects and analyzes data related to the assets, debts, income, and monthly expenses of a disabled individual or participant. In general, the information is used by evaluation and reporting modules to create a budget, help the disabled individual or participant prepare for the unexpected, identify opportunities for saving money, identify other sources of support besides SSDI, protect assets, and minimize tax liability.

More specifically, DLPS provides the disabled individual with financial planning and related assistance by gathering a disabled individual's personal and financial information through an on-line survey system or module accessed via a secure Internet environment, operating through appropriately programmed computers managed by the DLPC. Once the disabled individual's or participant's personal and financial information is gathered by the survey module, a reporting module of the DLPS generates a report which presents a detailed analysis of the disabled individual's or participant's financial situation to provide education regarding his or her financial situation (and how to possibly correct it). As part of the online report, an evaluation module within the DLPS provides in-depth explanations and suggestions on how to best manage and use the assets the disabled individual or participant has identified as owning; and to identify and explain (as necessary) potential resources available to the disabled individual or participant with their associated financial impact highlighted when available. The DLPS further provides the disabled individual with a contact to a DLPS specialist or advisor to help review the DLPS report, answer basic questions and provide more assistance where possible. The DLPS specialist can further provide expanded personalized financial counseling service for an extended period at an additional cost.

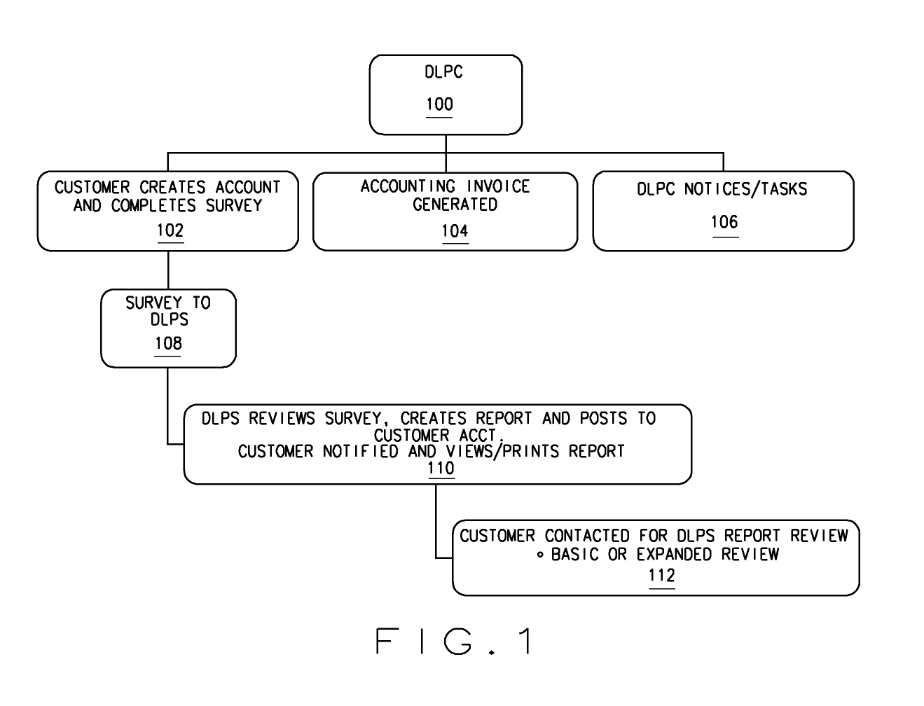

The process flow shown in FIG. 1 provides an overview of how a customer (i.e., a disabled individual or participant) and a DLPS specialist or Service Provider may interact with one another in relation to the DLPS. More specifically, the DLPS provides the following: DLPS marketing materials and messaging distributed by the DLPC (Box 100); customer enrollment, data entry, and account set-up (Box 102); payment (Box 104); generation of notices and tasks (Box 106); transfer of responses from customers to the DLPC centralized computer and a DLPS specialist (Box 108); and posting and retention of the generated results (DLPS report) to the customer (Box 110).

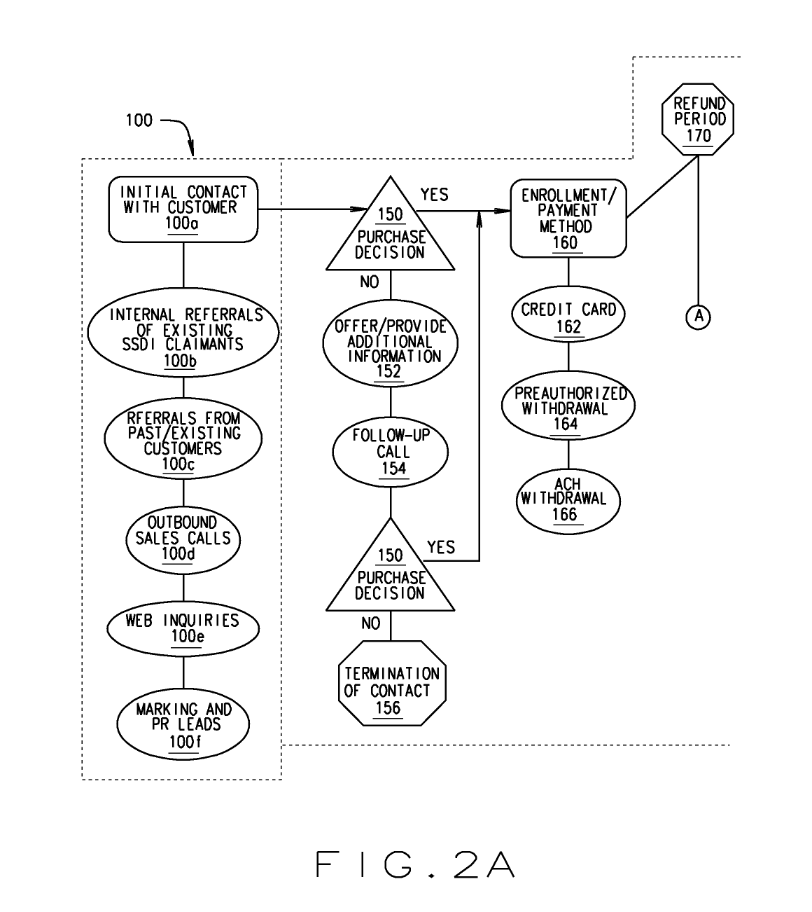

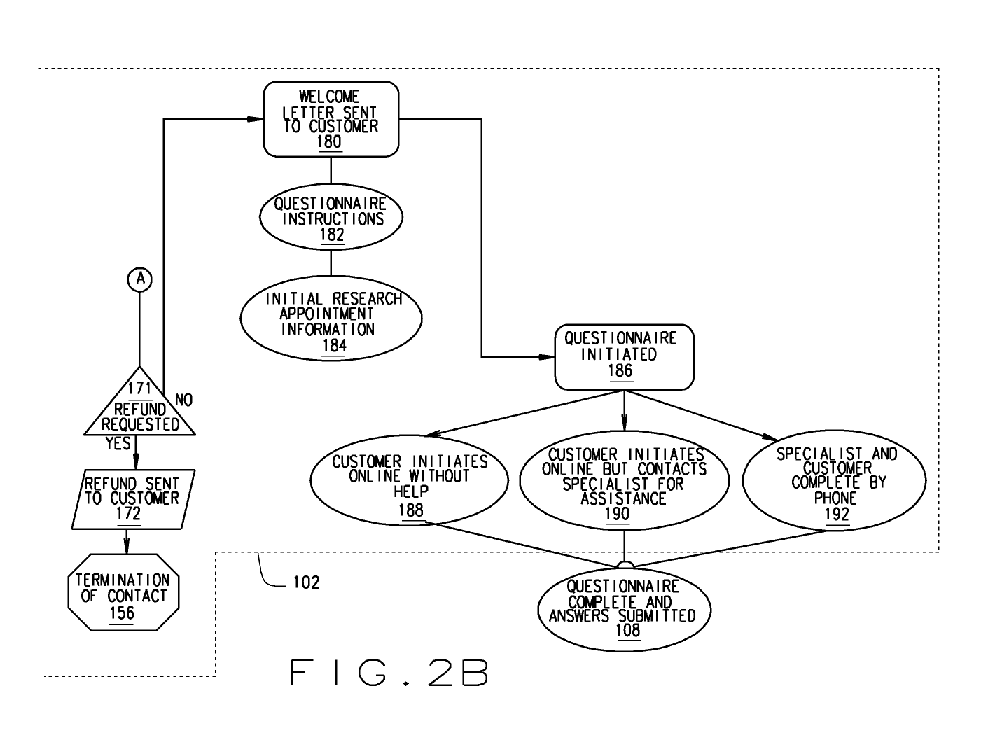

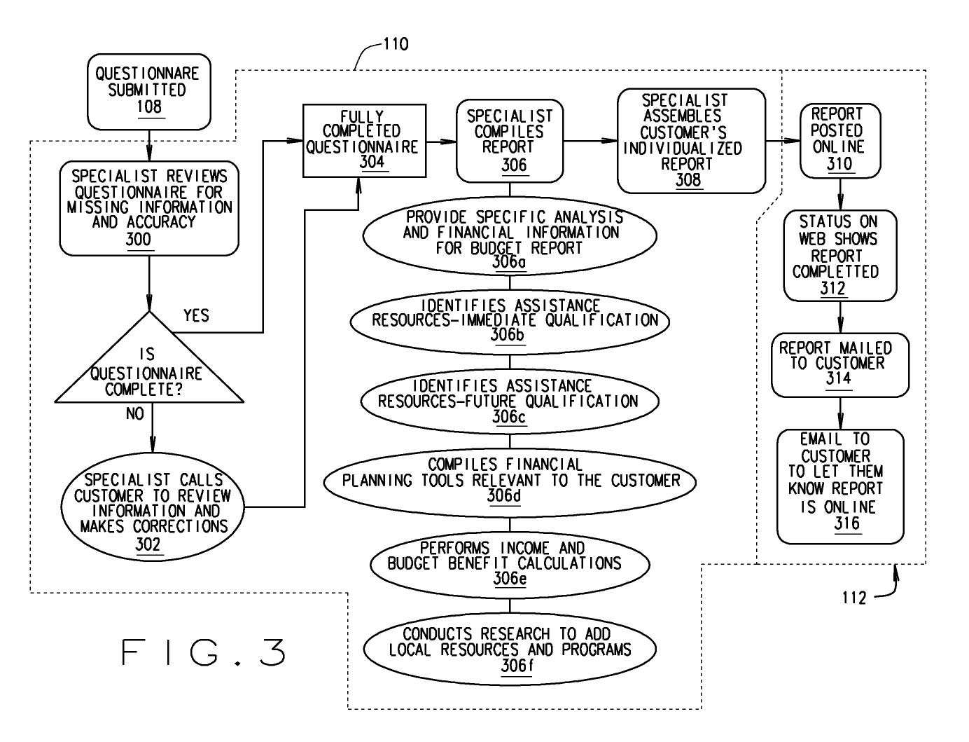

A detailed illustration of the processes flow of FIG. 1 can be seen in FIGS. 2A, 2B, 3, and 4. Initial contact with a disabled individual or participant (Box 100) may originate through a variety of different means. For example, as shown in FIG. 2A, the initial contact (Box 100a) may be established by internal referrals of existing SSDI claimants (Box 100b), by referrals from existing or past customers of the Service Provider (Box 100c), by outbound sales calls from the Service Provider (Box 100d), by inquiries generated through an online interactive website (Box 100e), or by marketing and public relations leads of the Service Provider (Box 100f).

Following the initial contact with the customer, the disabled individual or participant must determine if they will purchase the services of the Service Provider to provide them with the available forms of assistance (Box 150). If the customer elects not to purchase the services from the Service Provider, the DLPS specialist may follow-up with the customer to provide additional offers or information (Box 152) or via telephone (Box 154) to confirm the customer's decision. If the customer reaches a final decision not to purchase the services, the contact is terminated (Box 156).

In the event the disabled individual or participant elects to proceed with the purchase of services from the Service Provider, i.e., becomes a paying customer, an account is created (Box 102), and payment information is required (Box 160). For example, payment information may be provided to the Service Provider in the form of a credit card (Box 162), a pre-authorized bank account withdrawal (Box 164), or an ACH withdrawal of funds (Box 166). Those of ordinary skill in the art will recognize that other forms of payment or payment plans may be mutually arranged between the disabled individual or participant and the Service Provider. Once payment has been provided, the customer has a limited period of time during which a refund may be requested (Box 170). In the event a refund is requested (Box 171), the funds are returned to the customer (Box 172), and the contact is terminated (Box 156).

Once a disabled individual or participant has elected to purchase the services offered by the Service Provider through the DLPC, and has provided the appropriate payment, suitable welcome correspondence is generated and sent to the disabled individual or participant (Box 180), advising them of the next steps in the process, and including instructions on completing the appropriate questionnaires associated with the services they have purchased (Box 182) and identifying initial information which is required to evaluate the disabled individual's or participant's situation (Box 184). If the disabled individual or participant is a current or former claimant represented by the Service Provider associated with the DLPC, the centralized computer may be programmed to pre-populate information intake fields in the account and survey interface (Box 102) using previously stored data once the customer is uniquely identified to the system.

Once the customer has been informed of the need to provide information in response to the appropriate questionnaires (Box 186), they may supply the requested information themselves online via a secure website (Box 188), they may request assistance from the Service Provider (Box 190), or they may require the Service Provider to contact them directly to obtain the required information (Box 192). Once the necessary information has been acquired from the disabled individual or participant, the completed questionnaire and answers are submitted to the centralized computer of the DLPC system for further processing (Box 108).

Data collected at the DLPS via the customer surveys (Box 108) may include data on existing income, income sources, expenses, and available assets. Additional customer surveys are configured to collect information from the customer as may be required to utilize major federal benefit and financial planning tools and resources potentially available to the customer. In a preferred embodiment, the DLPS survey information would be an on-line, or otherwise user friendly survey, that would ascertain information regarding the customer's financial assets or status.

For survey questions related to net worth, the survey questions provided to the customer may be related to asset types (e.g., home, retirement accounts), asset values, liabilities, etc. as required by standard net worth calculators. For survey questions related to budgeting of income and expense, the survey question provided to the customer may be related to detailed monthly expenses, expenditures, available income, worker's compensation benefits, etc. as required by standard budgeting calculators. For survey questions related to long term disability income, the survey questions provided to the customer may be related to questions on insurance coverage (yes/no), carrier name, monthly income, expiration. The customer surveys may include other questions to be determined as required to extract the necessary information from the customer.

To the extent that the required information has already been collected and stored by the Service Provider as a result of prior representation of the customer for other core services, the DLPS can access the information through the centralized computer in the DLPC based on survey responses.

Once the DLPS survey questions are completed and submitted by a customer to the DLPC (e.g., through the DLPC centralized computer), a Service Provider specialist may review the questionnaire data for accuracy and to identify any required information which may be missing (Box 300). If any discrepancies are noted, the specialist may contact the disabled individual or participant to obtain the required information (Box 302). Once the questionnaire data is complete (Box 304), the data is utilized to generate one or more reports tailored to the disabled individual's or participant's particular situation (Box 306). Within the DLPC centralized computer system, submitted online survey responses are tied to relational database tables and suitably programmed software, i.e. an extraction module, extracts basic information from the survey responses. Information pulled from the relational tables by the extraction modules for each disabled individual or participant is combined into a preliminary DLPS report by a reporting module generated for a DLPS advisor or specialist to review and modify as required, for example, by adding personalized content where possible.

The generated reports may provide specific analysis and financial information for a budget (Box 306a), may identify assistance resources for which the disabled individual or participant is immediately qualified (Box 306b) or may be qualified for in the future (Box 306c), provides a set of financial planning tools which are relevant to the disabled individual or participant (Box 306d), provides income and budget benefit calculations (Box 306e) and identifies local resources and programs available to the disabled individual or participant (Box 306f). The generated reports are then compiled (Box 308) and made available to the disabled individual or participate (Box 310). The disabled individual or participant is notified of the available information, and their account status is updated within the system to reflect the changes (Box 312). Copies may be sent via postal service delivery (Box 314) or via e-mail (Box 316).

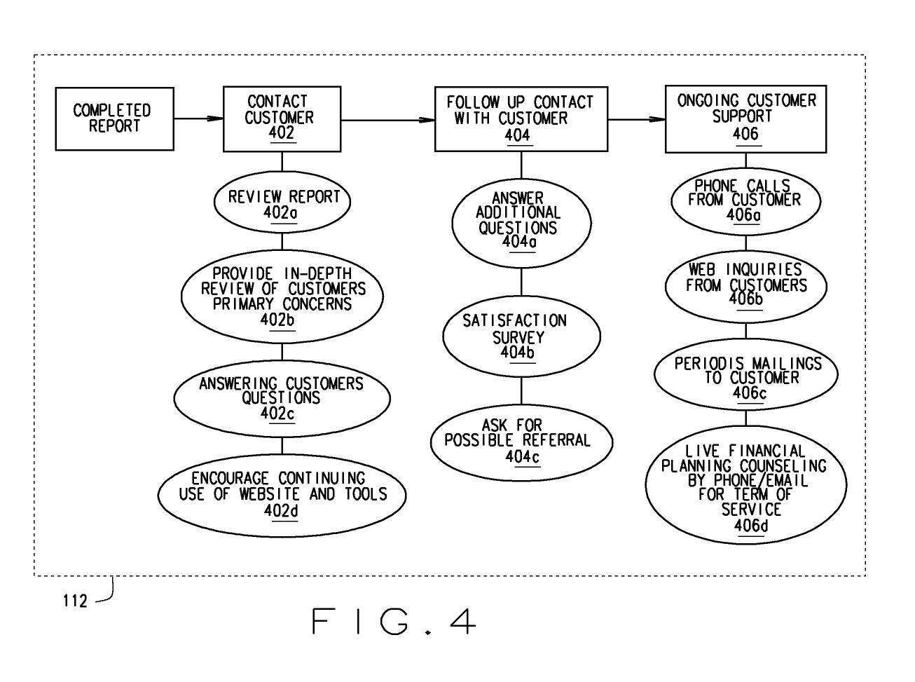

Once DLPS review is completed, the resulting reports are made available by the reporting module for viewing/printing/downloading by the customer in an accessible online account interface, and the customer is notified of the availability of the reports. Optionally, as shown in FIG. 4, an advisor from the DLPS may contact the customer directly (Box 402), to assist in reviewing the report as needed (Box 402a), to respond to any concerns the customer may have regarding the results of the reports (Box 402b), to answer any questions (Box 402c) and to encourage the customer to utilize available resources from the DLPC website (Box 402d). Follow-up support (Box 404) and on-going support (Box 406) may be provided by the Service Provider specialist to the disabled individual or participant as required. This may include responding to additional questions regarding the reports (Box 404a), providing a customer satisfaction survey (Box 404b), seeking referrals (Box 404c), and responding to other on-going matters (Boxes 406a-406d).

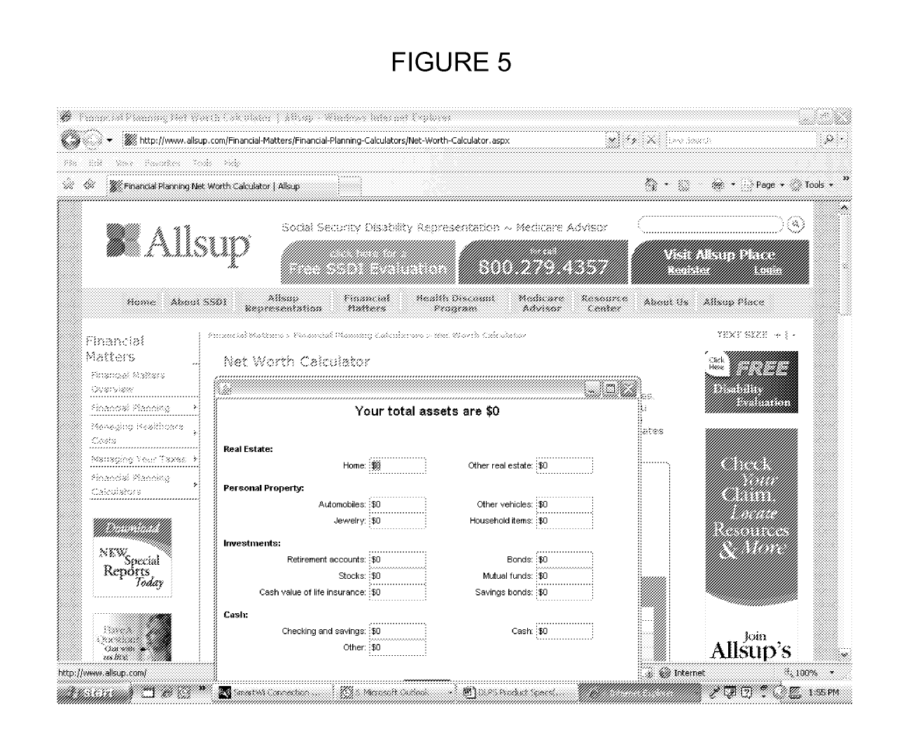

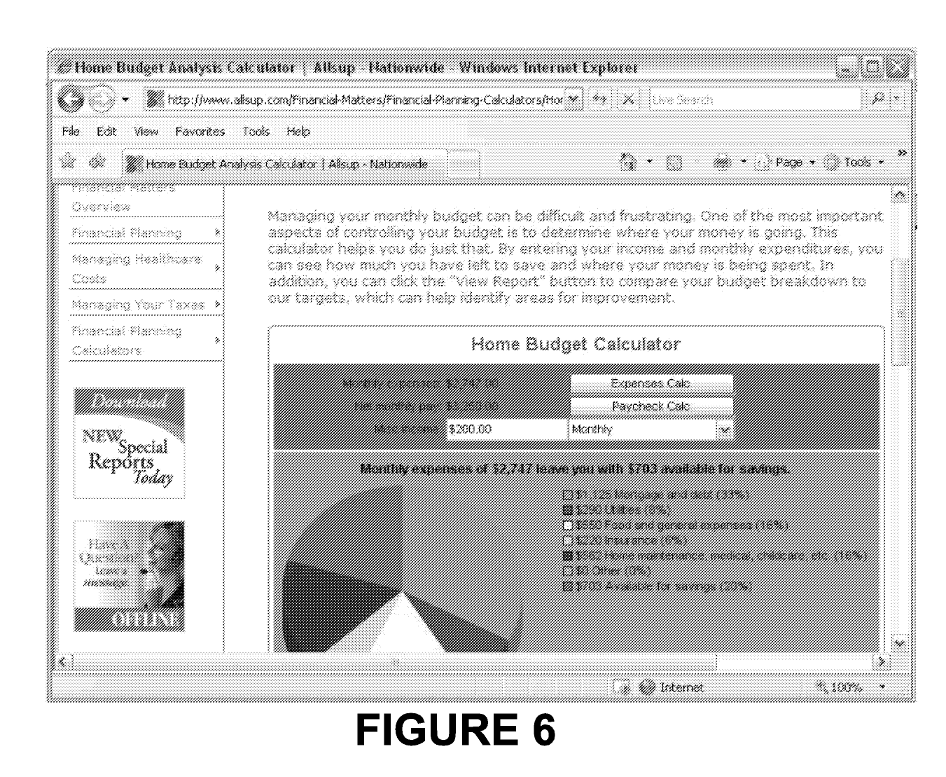

The information in a DLPS report can be categorized into four general sections. In the first section, a financial overview is provided, based on the information received from the disabled individual through the intake survey data. This financial overview may include a presentation of net worth and budgeting calculations, such as shown in FIGS. 5 and 6, as well as budgeting tips and suggestions on trimming current expenses. Relevant tax information may be included, such as the customer's current income tax bracket, as well as potential tax breaks, rebates, credits, etc. available to somebody in the customer's situation, and tax planning considerations for the year (e.g., deductibility of medical expenses). Finally, the financial overview may include explanations of options for utilizing existing assets (methods, pros and cons, tax implications). Such existing options may include, but are not limited to assets such as home equity and retirement savings. See: Appendix A and Appendix B for sample financial review questions and answers. It will be appreciated that the examples and sample explanations set forth in Appendix A and Appendix B are for purposes of illustration only.

In the second section of the DLPS report, an asset management plan is presented, again based on the information provided by the disabled individual through the intake survey data. The asset management plan provides suggestions on possible ways to better utilize existing assets to generate cash flow, together with a discussion of asset/benefit protection.

A third section of the DLPS report identifies to the disabled individual or participant any and all of the Service Provider's products and services which are related to the disabled individual's or participant's specific situation (e.g., the Medicare Advisor Service (MAS), lump-sum management, and other services, as set out in greater detail below).

Finally, the DLPS report provides a resource listings section based on the disabled individual's or participant's personal data and location. Within this section, detailed information is conveniently gathered in one report on various helpful resources provided by federal, state and local governments, and both nonprofit and for-profit private entities. Examples of resources include government and private benefit programs available to help the disabled individual or participant save money on, or pay for food, prescription drugs, health care, utilities, and taxes. These programs may include: disability assistance; legal/counseling services; tax assistance; tax credits, deductions, rebates; food/nutrition assistance programs; financial/living assistance; energy/utility assistance (gas, electric, telephone, water); housing and housing improvement; healthcare assistance; childcare and child support; education and training; veteran benefits; Medicare/Medicaid; leisure (e.g., free federal park passes for disabled); condition-specific assistance; support groups; and volunteer opportunities. Preferably, the included information on such programs identifies program names, program explanations, benefits summaries, program eligibility, and information on how the disabled individual or participant may apply for the listed programs, together with appropriate contact information.

In addition to receiving access to an online report from the DLPS, the disabled individual or participant utilizing the system has the additional option of having personal assistance from a DLPS service advisor via phone through any step of the process. An in-person review will be scheduled once the report is completed to personalize the DLPS and allow the DLPS personnel to discuss/highlight/market particular areas as needed (e.g., benefit protection issues). To ensure this personal contact occurs, the DLPC computer is configured with suitable software modules to provide an interface and scheduler to track and respond to contacts between customers and DLPS personnel. The option to receive personal assistance from a DLPS service advisor may be rendered available to all disabled individuals or participants as part of the system, or may be implemented as a premium level of service.

In addition to generating reports to the disabled individual or participant, the DLPS system may be configured to tie in with other existing and future Service Provider programs and services. For example, a customer's income and assets may be too high to qualify for public aid, yet he or she cannot afford health insurance premiums (possible health discount program candidate). The DLPS report can help identify such opportunities, which the DLPS advisor can discuss in more detail while speaking with the disabled individual or participant.

Those of ordinary skill in the art will recognize that the DLPS is operated on a centralized computer system configured with suitable software instructions and programs. The software includes, but is not limited to, software designed for financial planning, relational database software and other software custom designed by the Service Provider to carry out various aspects of the invention. The base DLPS computerized systems provide the following functionality: an interactive, web-based front-end which enables a customer to enter all of his or her relevant financial and health care data; logic which determines the most appropriate way for the disabled individual or participant to allocate his or her limited resources to optimize financial and health care position, including data elements and decision rules; and the generation of reports which confirm the inputs collected from the disabled individual or participant, and which recommends the optimized mix of financial and health care products.

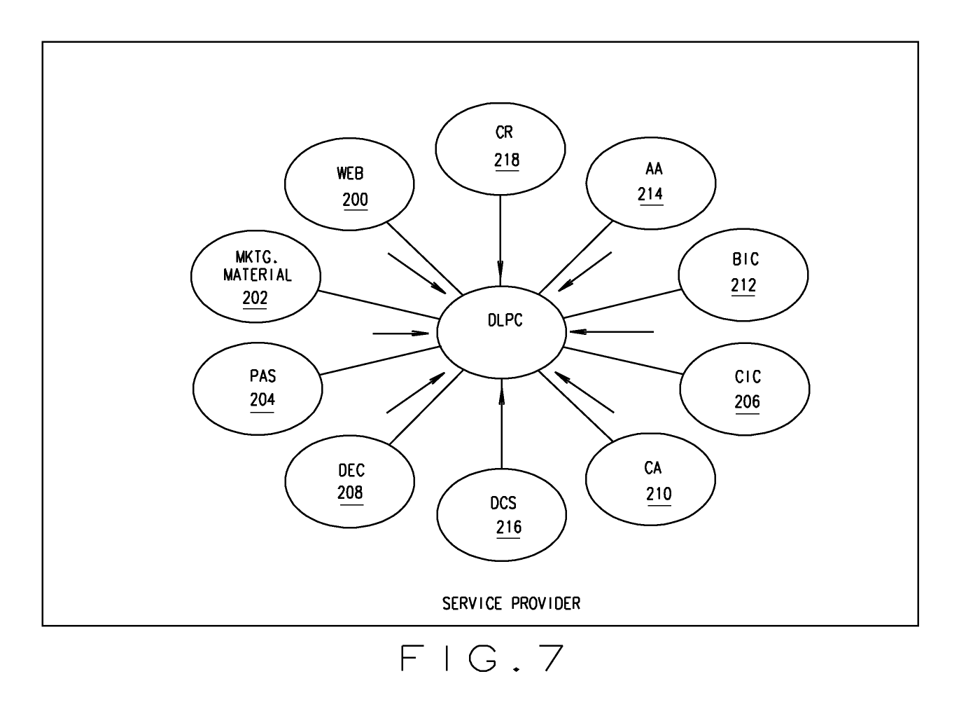

In order to function efficiently and to provide useful information to a wide range of disabled individuals or participants, the DLPS system is configured to interact with, and exchange data with, a number of different systems or departments associated with a Service Provider, such as shown in FIG. 7. For example, DLPS leads on disabled individuals or participants who may benefit from assistance through the Service Provide may come to the DLPC from any Service Provider department, the Service Provider's website (Box 200) and various marketing and PR collateral sources and efforts (Box 202). Other possible interactive departments within the Service Provider system include Post Award Services (PAS, Box 204), a Customer Information Center (CIC, Box 206), a Disability Evaluation Center (DEC, Box 208), Claims Assistants (CA, Box 210), a Benefits Information Center (BIC, Box 212), Appeals Analysts (AA, Box 214), Disability Claims Specialists (DCS, Box 216), and Customer Relations departments (CR, Box 218).

Services provided by the DLPS to disabled individuals or participants through the DLPC may be offered free of charge as part of a comprehensive package to the customers from the Service Provider, or may be deemed to have a value which is billed to the disabled individuals or participants. As shown in FIG. 2A, DLPS customers can pay for the services by credit card payments (Box 162) or ACH withdrawal (Box 166) at the time of enrollment. Another alternative is to set up a separate preauthorization for future withdrawal (Box 164) once a disabled individual claimant is awarded SSDI, such as provided in U.S. Pat. No. 7,260,548 for Long Term Disability Overpayment Recovery Service With Post Award Service and Savings Program and Financial Assistance (ORS), which is incorporated herein by reference, or other benefits.

Credit card payments (Box 162) and ACH withdrawals (Box 166) are the preferred ways to pay for the DLPS. If a pre-authorization payment (Box 164) method is used, the following are needed: coordination with IPS of second pre-authorization other than representation; communication between the Service Provider's individual payment services (IPS) group and the DLPC of signed DLPS pre-authorizations; task/scheduling of pre-authorizations sent to customer and then back to IPS; coordination with accounting; and coordination of customer notification and fee payment/sweeps.

An optional aspect of the present invention is the inclusion of tax preparation services and guidance specifically to support individuals with disabilities. Tax services can be a component of the DLPS or can be a stand-alone service provided by the Service Provider. In one aspect of the invention, Tax services are provided through, or managed by, the DLPC. In any event, in a preferred aspect, independent tax experts familiar with tax issues faced by disabled individuals will provide expert tax preparation and counseling on the tax ramifications of the disabled individual's DLPS report, SSDI payments, lump sum cash payments, and so forth.

Another aspect of the invention is a Medicare Advisor Service (MAS) designed to aid disabled individuals or participants who may qualify for Medicare, to select a proper Medicare program, such as a Medicare Advantage Plan or traditional Medicare plans, that meets specific needs or criteria of the customer and assists them with the enrollment process. Medicare Advantage Plans are health plan options that are part of the Medicare program. If the enrolled Medicare customer joins one of these plans, he or she generally gets all of their Medicare-covered health care through that plan. This coverage can include prescription drug coverage. Medicare Advantage Plans include: Medicare Health Maintenance Organization (HMOs); Preferred Provider Organizations (PPO); Private Fee-for-Service Plans; and Medicare Special Needs Plans.

When a disabled individual or participant enrolls in a Medicare Advantage Plan, he or she uses the health insurance card that they receive from the plan for health care. In most of these plans, generally there are extra benefits and lower copayments than in the Original Medicare Plan. However, the disabled individual or participant may have to see doctors that belong to the plan or go to certain hospitals to get services. To join a Medicare Advantage Plan, a customer must have Medicare Part A and Part B. The customer will have to pay a monthly Medicare Part B premium to Medicare. In addition, the customer might have to pay a monthly premium to the Medicare Advantage Plan for the extra benefits that plan offers.

Selecting the right Medicare coverage can be difficult and extremely time consuming. The purpose of the Medicare Advisor Service (MAS) aspect of the present invention is to help a disabled individual or participant understand the Medicare options available to him and narrow down the plan choices to those plans most likely to meet the disabled individual's or participant's needs. The MAS component of the system provides in-depth assessment of Medicare Advantage and traditional Medicare plans available to beneficiaries and assists them through the enrollment process. Because Medicare consists of so many parts (Medicare Parts A, B, C and D), knowing what might work best for any one individual can be incredibly confusing. The MAS component of the system is a tool for Medicare-eligible people (beneficiaries) to understand what health care options they have available to them under Medicare. Its purpose is the help them make the right choices for them when it comes to health care coverage. In one aspect of the invention, MAS is offered to a disabled individual through the Disability Life Planning Service (DLPS). However, persons other than disabled individuals can use the service as well.

The MAS aspect of the present invention consists of two primary components: a customized report tailored to the customer's needs, and internal knowledge and systems that help the Service Provider support the service. The customized report is generated from the Service Provider's internal systems. For example, the MAS Report can be generated through the Disability Life Planning Center or the Service Provider's core business structure, if the recipient of the report is not a disabled individual. Hence, the Service Provider offers various interfaces for participants, such as through the DLPC, as shown in FIG. 1, or through a MAS component of the Service Provider's core business. In any event, each customer is interviewed extensively to understand his or her needs and preferences. The data received is put into the Service Provider's systems, for example, into a computer system through the DLPC. The data is appropriately analyzed and compared to a database of available Medicare plans to create a report that outlines all the Medicare options available, highlighting the top three that most closely match the disabled individual's or participant's criteria. The report is then sent to the disabled individual or participant for his or her review. After the customer has an opportunity to review it, the Service Provider representative who created the report follows up with the customer to go through the report step by step, answering any questions the customer may have.

The MAS aspect of the present invention relies on the extensive Medicare knowledge of the Service Provider's program specialists and on the constantly-evolving Service Provider systems interfaces, which support the program specialists. Each program specialist consults with a customer and researches the individual's health care options. Individuals using the MAS aspect of the invention also have access to the program specialists, receiving timely responses to questions and follow-up calls and e-mails to make sure each customer who uses the service is covered. The systems are timely updated, supported by a responsive, knowledgeable systems staff who participate in development and maintenance processes of the MAS product.

The MAS aspect of the present invention is offered to Medicare-eligible customers, participants, or disabled individuals through internal referrals within the Service Provider, via web site “hits” or contact, via e-mail advertisement campaigns, or through direct mail campaigns. Internal referrals, i.e. referrals between the Service Provider's various departments are usually people under the age of 65 who are eligible for Medicare due to disability. In general, these are individuals the Service Provider has helped through the SSDI award process, and who are unsure how to choose a proper Medicare plan. Other potential beneficiaries may learn about the MAS service through the Service Provider's Web site. The Service Provider may also send out e-mail campaigns to a variety of individuals, typically people who the Service Provider served through the SSDI process.

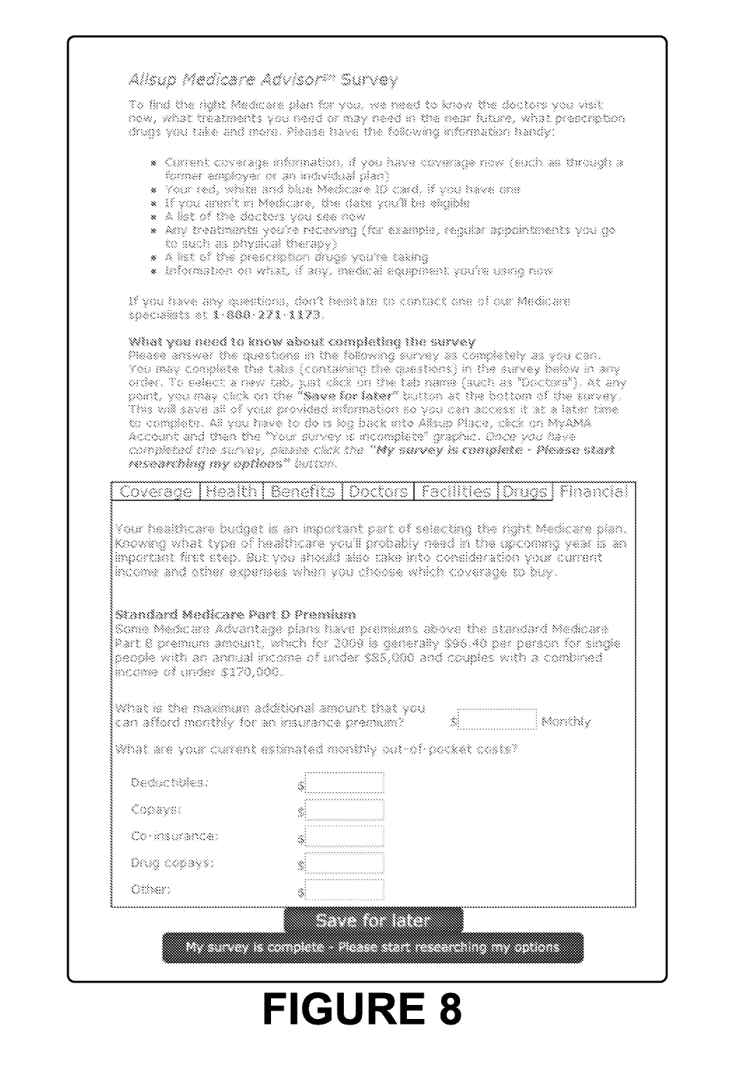

In any event, during initial contact a program specialist informs the individual about the Medicare Advisor Service, then asks a few questions related to the individual's health condition and Medicare eligibility to make sure that the MAS would be a good choice for him or her. The program specialist making the call enters the information they receive from the individual into the DLPC computer system to pre-populate the MAS call screens, such as illustrated in FIG. 8, in the event the individual selects the MAS. This provides some basic information about the customer's eligibility, current coverage and health situation. Once an individual has selected the MAS, the program specialist schedules a time for a Service Provider researcher to call the customer and walks him or her through completion of the MAS survey.

During the MAS survey call, the Service Provider researcher asks the disabled individual or participant a series of questions about their health, which doctors they see, what facilities they visit, medical equipment they're using and what prescriptions they're taking. They also gather information about what the customer is looking for in an insurance plan—if they want vision and dental included, for example. The researcher also asks some basic questions about the customer's financial status. All this information gives the researcher the information he or she needs to be able to find plans in the customer's area that will meet their needs. Once the survey has been completed, the Service Provider researcher then reviews all the plans in the customer's area and creates a MAS report using the programmed computer system and databases of available plans. In a preferred aspect of the invention, this analysis of the customer's survey responses comparing the available plans in the customer's geographic area is performed by an appropriately programmed computer to generate a report of those plans which match the customer criteria input by the Service Provider researcher. In a preferred aspect of the invention, the analysis determines the top three plans most likely to meet his or her needs, and the Service Provider researcher then creates the MAS report.

The MAS report is run through at least two quality checks to ensure that the information provided is appropriate, complete and understandable. If the report fails any of the quality checks, it is re-reviewed. Once the report has cleared all applicable quality checks, it is printed and mailed to the customer for review.

Once the Service Provider researcher has provided the disabled individual or participant with an opportunity to review their report, the Service Provider researcher calls back to go over the report with the customer and answer any questions he or she may have. If necessary, the researcher can schedule a conference call between the customer and a representative from the plan the customer is interested in joining to assist in the enrollment process or simply to help with any questions.

Through another feature of the MAS, the Service Provider provides trouble-shooting and serves as an advocate for the disabled individual or participant with the selected plan and plan provider. It will be appreciated that although this additional service can be supplemental to the MAS program, the Service Provider may use its expertise to function as a trouble-shooter and advocate for other individuals with Medicare even though the individual does not utilize the MAS.

Another component of the present invention enables the Service Provider to advise a disabled individual or participant on the use of a Healthcare Discount Card. A Healthcare Discount Card allows users to obtain discounted healthcare services from anyone who accepts the specific card. The Healthcare Discount Card provides the individual and family members with a wide range of discounts for healthcare services, including doctor visits, medical tests, medical equipment, hospital stays and drugs. One aspect of the Healthcare Discount Card component of the present invention is designed to support the uninsured or under insured individual, particularly during the two-year waiting period for Medicare benefits immediately following an SSDI award. The Healthcare Discount Card is not insurance, but may offer discounts on medical services (including many not covered by standard insurance policies) for a nominal monthly fee.

Another component of the present invention is a process implemented by the Service Provider by which the disabled individual's monthly SSDI award and retroactive award is allocated directly to a Stored Value Card each month. The Stored Value Card provides the individual with the security and flexibility of a debit and credit card product, and better allows the disabled individual to monitor and control spending, as well allocation of limited financial resources.

Another component of the invention is a Lump Sum Management service available through the Service Provider. An SSDI claimant may, under certain circumstances, elect a conditional, final Long Term Disability (LTD) insurance lump sum distribution from the individual's private insurer. Under the Lump Sum Management (LSM) aspect of the present invention, an LTD carrier can eliminate its remaining liability leaving the Service Provider to provide the ongoing financial and healthcare services that will be needed indefinitely by the individual. The LSM service also assists the individual in managing their retroactive SSDI award and in acquiring lump-sum payouts from LTD insurance, worker's compensation or personal injury lawsuits.

The present disclosure can be embodied in-part in the form of computer-implemented processes and apparatuses for practicing those processes. The present disclosure can also be embodied in-part in the form of computer program code containing instructions embodied in tangible media, such as floppy diskettes, CD-ROMs, hard drives, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A method performed on a general purpose computer incorporating sub-modules deployed within the computer performing the following steps for providing financial planning and assistance to a customer, comprising:
providing a set of survey questions to the customer through a survey module;
receiving a set of answers to said set of survey questions from the customer through the survey module;
accessing, through an evaluation module, one or more databases storing data associated with a plurality of financial planning and assistance services, said plurality of financial planning and assistance services having one or more required qualifications for individual participation;
extracting, in said evaluation module, qualification criteria from said received set of answers for comparison with said one or more required qualifications for individual participation in said financial planning and assistance services; and
generating, through a reporting module, a report of financial planning options and assistance services for which said customer is qualified based on said comparison between said one or more required qualifications and said extracted qualification criteria.

2. The method of claim 1 for providing financial planning and assistance to a customer further including delivering said report of financial planning and assistance services to the customer through said reporting module.

3. The method of claim 2 for providing financial planning and assistance to a customer wherein said report is further delivered to a Service Provider through said reporting module.

4. The method of claim 3 for providing financial planning and assistance to a customer wherein responsive to said delivered report, the service advisor contacts the individual to provide advice associated with at least one of a Healthcare Discount Card, a Stored Value Card, or a Lump Sum Management Service.

5. The method of claim 1 for providing financial planning and assistance to a customer wherein said report of financial planning and assistance services further includes a financial overview of the customer, an asset management plan for the customer, and a listing of resources available to the customer;
wherein said financial overview is prepared by said evaluation module from said received set of answers;
wherein said asset management plan is prepared by a planning module using said received set of answers and a set of stored financial planning guidelines; and
wherein said listing of resources is prepared by said reporting module using said received set of answers and said data accessed in said databases.

6. The method of claim 5 for providing financial planning and assistance to a customer wherein said financial overview of the customer includes at least one presentation selected from a set of presentations including net worth calculations, budgeting calculations, budgeting tips, expense trimming suggestions, tax information, tax planning, and asset utilization options.

7. The method of claim 5 for providing financial planning and assistance to a customer wherein said asset management plan for the individual provides options on cash flow generation and an analysis of asset/benefit protection options for the customer.

8. The method of claim 5 for providing financial planning and assistance to a customer wherein said listing of resources includes identification of public programs, private programs, or resources for which the customer is qualified, said programs or resources may include, but are not limited to, disability assistance, legal counseling, tax assistance, tax credits, food assistance programs, financial assistance, utility assistance, housing assistance, healthcare assistance, child support services, education services, and other opportunities.

9. The method of claim 1 for providing financial planning and assistance to a customer wherein said set of survey questions are related to the customer's net worth, budgeting of income and expense, and any long-term disability income.

10. The method of claim 9 for providing financial planning and assistance to a customer wherein said set of survey questions related to the customer's net worth include questions associated with asset types, asset values, and liabilities.

11. The method of claim 9 for providing financial planning and assistance to a customer wherein said set of survey questions related to budgeting of income and expense include questions associated with the customer's expenses, expenditures, available income, and benefits.

12. The method of claim 9 for providing financial planning and assistance to a customer wherein said set of survey questions related to long-term disability income include questions associated with the customer's insurance coverage, insurance carriers, disability income amounts, and disability income policy expirations.

13. The method of claim 1 for providing financial planning and assistance to a customer further including retrieving, through said survey module, information previously stored in a customer database associated with the customer upon a unique identification of the customer by said survey module.

14. The method of claim 1 for providing financial planning and assistance to a customer further including the step of tracking, through a monitoring module, interaction between the customer and a service advisor.

15. The method of claim 1 for providing financial planning and assistance to a customer further including communicating, through an interface module, said received set of answers and said report of financial planning options and assistance services for which the customer is qualified, to a computer system associated with a separate Service Provider department, said separate Service Provider department including, but not limited to, Post Award Services, a Customer Information Center, a Disability Evaluation Center, Claims Assistance, a Benefits Information Center, Appeals Analysis, Disability Claims Specialists, and Customer Relations.

16. The method of claim 1 for providing financial planning and assistance to a customer further including storing said received set of answers and said report of financial planning options and assistance services for which the customer is qualified in an accessible data storage component.

17. The method of claim 1 for providing financial planning and assistance to a customer further including communicating, through an interface module, said received set of answers and said report of financial planning options and assistance services for which said customer is qualified, to a computer system associated with a tax preparation service module.

18. The method of claim 1 for providing financial planning and assistance to a customer further including communicating, through an interface module, said received set of answers and said report of financial planning options and assistance services for which said customer is qualified, to a Medicare Advisor Service system, said Medicare Advisor Service system having a computer configured with a set of program instructions for evaluating at least said set of answers to identify available Medicare options available to the customer, and for generating one or more reports associated with said identified available Medicare options.

19. The method of claim 1 for providing financial planning and assistance to a customer wherein said customer is a disabled individual.
